(19) United States
(12) Patent Application Publication
(10) Pub. No.: US 2023/0325287 A1
(43) Pub. Date: Oct. 12, 2023

(54) DATA BACKUP METHOD AND APPARATUS, DATA RECOVERY METHOD AND APPARATUS, AND STORAGE MEDIUM

(71) Applicant: ALIBABA CLOUD COMPUTING CO., LTD., Hangzhou City, Zhejiang (CN)

(72) Inventors: Yang CHEN, Zhejiang (CN); Ruo WANG, Zhejiang (CN); Bodong YANG, Zhejiang (CN); Huan LIU, Zhejiang (CN)

(21) Appl. No.: 18/043,502

(22) PCT Filed: Aug. 27, 2021
(86) PCT No.: PCT/CN2021/114900

§ 371 Date: Feb. 28, 2023

(30) Foreign Application Priority Data
Sep. 1, 2020 (CN) 202010904057.X

(51) Int. Cl. G06F 11/14; G06F 16/11; G06F 16/16

(52) U.S. Cl. CPC G06F 11/1469; G06F 16/122; G06F 16/162; G06F 11/1451; G06F 2201/84

(57) ABSTRACT

A data backup method and apparatus, a data recovery method and apparatus, and a storage medium are provided. The data backup method comprises: in response to a full backup command, performing full backup on data stored in a database, so as to generate full backup data (S4100); acquiring an incremental file corresponding to the full backup data, and writing, into the incremental file, a received write command and an execution timestamp of executing the write command (S4200); and backing up the full backup data and the incremental file (S4300).

The present application claims the priority to Chinese Patent Application No. 202010904057.X, entitled “DATA BACKUP METHOD AND APPARATUS, DATA RECOVERY METHOD AND APPARATUS, AND ELECTRONIC DEVICE” filed on Sep. 1, 2020, the disclosure of which is incorporated by reference herein in its entirety.

### TECHNICAL FIELD

The present description relates to the field of database technology, and more specifically, relates to a data backup method based on a database, a data recovery method based on a database, a data backup apparatus based on a database, a data recovery apparatus based on a database, an electronic device, and a computer-readable storage medium.

### BACKGROUND

As important technologies of a database, online backup and instant recovery are paid more and more attention by database users and designers. The online backup and instant recovery may not only improve the reliability of the database, but also improve the flexibility of the database. The instant recovery is generally common in relational databases (such as PostgreSQL), because such databases generally record wal (write ahead log) or binlog logs to ensure ACID (atomicity consistency isolation durability), and these logs contain various information, such as a timestamp, a transaction id, etc., required for the instant recovery.

Redis, as an in-memory and non-relational database, itself provides data persistence manners, such as RDB, AOF, etc. The RDB is a data persistence manner of the Redis, and the Redis may save current dataset snapshots in a memory as an rdb file. The AOF is a data persistence manner of the Redis, and the Redis may append each of commands to an aof file in the form of statement. However, there is no information, such as timestamp, etc., in the rdb file and the aof file, so that the instant recovery cannot be realized fundamentally.

Therefore, for the Redis, only RDB files may be used for the full backup and full recovery, which greatly limits the flexibility of the data backup and data recovery of the Redis.

### SUMMARY

One purpose of the present description is to provide a new technical solution of data backup and data recovery.

According to the first aspect of the present description, a data backup method based on a database is provided, which includes: performing, in response to a full backup command, full backup on data stored in the database, to generate full backup data; acquiring an incremental file corresponding to the full backup data, and writing, into the incremental file, a received write command and an execution timestamp of executing the write command; and performing backup on the full backup data and the incremental file.

Optionally, the performing, in response to the full backup command, the full backup on the data stored in the database, to generate the full backup data, includes: copying, in response to the full backup command, a main process to generate a subprocess, such that the main process processes a subsequently received command; and performing, through the subprocess, the full backup on the data stored in the database, to generate the full backup data.

Optionally, the method further includes: generating, in a case where a capacity of the incremental file reaches a preset capacity threshold value, a new incremental file corresponding to the full backup data; writing the received write command and the execution timestamp of executing the write command into the new incremental file; and performing backup on the new incremental file.

Optionally, the method further includes: determining a serial number of the write command in a preset incremental manner according to the execution timestamp; and writing the serial number of the write command into the incremental file.

Optionally, the method further includes: acquiring, in response to a command for deleting the incremental file, a target serial number carried in the command for deleting the incremental file; wherein, the target serial number is greater than a serial number of a write command last executed in the incremental file that has been backed up; and deleting an incremental file including a write command whose serial number is less than the target serial number.

According to the second aspect of the present description, a data recovery method based on a database is provided, which includes: acquiring, in response to a data recovery request, a recovery date carried in the data recovery request; acquiring target full backup data corresponding to the recovery date and a target incremental file corresponding to the target full backup data; wherein, the target full backup data and the target incremental file are obtained through the method according to the first aspect of the present description; and loading the target full backup data and the target incremental file, to obtain recovered data.

Optionally, loading the target full backup data and the target incremental file to obtain the recovered data, includes: acquiring a full backup index file and an incremental list file, which are generated by a peripheral system according to the target full backup data and the target incremental file, wherein the full backup index file is used to represent both the target incremental file corresponding to the target full backup data, and a serial number of a write command, corresponding to the target full backup data, in the target incremental file, and the incremental list file is used to represent a generation order of the target incremental file; parsing the full backup index file and the incremental list file to obtain a parsing result; loading the target full backup data; and loading, after the target full backup data is loaded successfully, the target incremental file according to the parsing result, to obtain the recovered data.

Optionally, the method further includes: acquiring a timestamp file, which is generated by the peripheral system according to a recovery timestamp within the recovery date; and parsing the timestamp file to obtain the recovery timestamp, and loading the target incremental file according to the recovery timestamp, to obtain the recovered data.

Optionally, the loading the target incremental file according to the parsing result and the recovery timestamp, to obtain the recovered data, includes: acquiring a target write command in the target incremental file sequentially according to the parsing result, and in a case where an execution timestamp corresponding to the target write command precedes the recovery timestamp, executing the target write command to obtain the recovered data.

According to the third aspect of the present description, a data backup apparatus based on a database is provided, which includes: a backup command response module, configured for performing, in response to a full backup command, full backup on data stored in the database, to generate full backup data; an incremental file writing module, configured for acquiring an incremental file corresponding to the full backup data, and writing, into the incremental file, a received write command and an execution timestamp of executing the write command; and a data and file backup module, configured for performing backup on the full backup data and the incremental file.

According to the fourth aspect of the present description, a data recovery apparatus based on a database is provided, which includes: a recovery request response module, configured for acquiring, in response to a data recovery request, a recovery date carried in the data recovery request; a data and file acquisition module, configured for acquiring target full backup data corresponding to the recovery date and a target incremental file corresponding to the target full backup data; wherein, the target full backup data and the target incremental file are obtained through the apparatus according to the third aspect of the present description; and a data and file loading module, configured for loading the target full backup data and the target incremental file, to obtain recovered data.

According to the fifth aspect of the present description, an electronic device is provided, which includes: the apparatus according to the third aspect or the fourth aspect of the present description; or a processor and a memory, wherein the memory is configured for storing instructions, and the instructions are used to control the processor to perform the method according to the first aspect or the second aspect of the present description.

According to the sixth aspect of the present description, a computer-readable storage medium is provided, which stores a computer program, wherein the computer program, when executed by a processor, implements the method according to the first aspect or the second aspect of the present description.

The beneficial effects of embodiments of the present description are that: in the case of performing the full backup on the database, the write command and the execution timestamp of the write command are also written into the incremental file, and the accurate backup of the database is achieved through both the full backup data and the incremental file, such that on the basis of ensuring overall compatibility, the database may support an instant recovery function after the backup of the database, and the database may accurately recover to data at any time based on the full backup data and the incremental file.

By the following detailed description of exemplary embodiments of the present description with reference to the accompanying drawings, other features and advantages of the present description will become clear.

### BRIEF DESCRIPTION OF THE DRAWINGS

The accompanying drawings, which are incorporated in the present description and constitute a part of the present description, show embodiments of the present description, and are used for explaining the principle of the present description together with description of the accompanying drawings.

FIG. 1 shows a block diagram of an example that may be used to implement a hardware configuration of an electronic device of an embodiment of the present description.

FIG. 2 shows a block diagram of another example that may be used to implement a hardware configuration of an electronic device of an embodiment of the present description.

FIG. 3 shows a schematic diagram of a scene of an embodiment of the present description.

FIG. 4 shows a schematic flow chart of a data backup method of an embodiment of the present description.

FIG. 5 shows a block diagram of a data backup apparatus of an embodiment of the present description.

FIG. 6 shows a schematic flow chart of a data recovery method of an embodiment of the present description.

FIG. 7 shows a block diagram of a data recovery apparatus of an embodiment of the present description.

FIG. 8 shows a flow chart of an example of a data recovery method of an embodiment of the present description.

FIG. 9 shows a block diagram of an example of an electronic device of an embodiment of the present description.

### DETAILED DESCRIPTION

Various exemplary embodiments of the present description will now be described in detail with reference to the accompanying drawings. It should be noted that, unless otherwise specified, relative arrangements, numerical expressions, and numerical values of components and steps described in these embodiments do not limit the scope of the present description.

The following description of at least one exemplary embodiment is really merely illustrative, and in no way serves as any limitation on the present description and applications or uses of the present description.

The techniques, methods, and devices known to ordinary technicians in the related field may not be discussed in detail, but in an appropriate case, these techniques, methods, and devices shall be considered as a part of the present description.

In all examples shown and discussed herein, any specific value should be interpreted as merely illustrative but not as a limitation. Therefore, other examples of the exemplary embodiments may have different values.

It should be noted that similar reference signs and letters indicate similar items in the following drawings. Therefore, once a certain item is defined in one drawing, the item does not need to be further discussed in the subsequent drawings.

<Hardware Configuration>

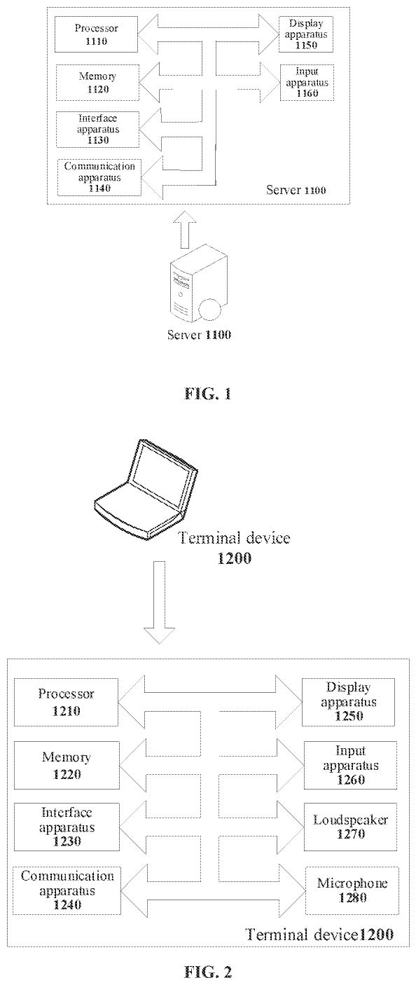

FIG. 1 and FIG. 2 are block diagrams of examples that may be used to implement a hardware configuration of an electronic device of an embodiment of the present description.

In an embodiment, as shown in FIG. 1, the electronic device 1000 may be a server 1100.

The server 1100 is a computer that provides processing, a database, and a communication facility. The server 1100 may be a distributed server across multiple computers or computer data centers, or an integrated server. Various types of servers are possible, for example, but are not limited to, network servers, news servers, mail servers, message servers, advertising servers, file servers, application servers, interaction servers, database servers, or proxy servers. In some embodiments, each of the servers may include hardware, software, an embedded logical component for performing an appropriate function which is supported or implemented by the server, or a combination of two or more such components.

In an embodiment, the server may be a blade server, a rack server, or a cloud server, etc. The server may also be a server group composed of multiple servers. The server may also be implemented as a cloud architecture, for example, the server is implemented by a server cluster deployed in a cloud. The server may also include one or more of the above types of servers, etc.

In this embodiment, the server 1100 may include a processor 1110, a memory 1120, an interface apparatus 1130, a communication apparatus 1140, a display apparatus 1150, and an input apparatus 1160, as shown in FIG. 1.

In this embodiment, the server 1100 may also include a loudspeaker, a microphone, etc., which is not limited herein.

The processor 1110 may be a desktop processor or a mobile processor that meets performance requirements, or a dedicated server processor, which is not limited herein. The memory 1120 includes, for example, an ROM (read only memory), an RAM (random access memory), a non-volatile memory (such as a hard disk), etc. The interface apparatus 1130 includes, for example, various bus interfaces, such as a serial bus interface (including an USB interface), a parallel bus interface, etc. The communication apparatus 1140 may, for example, perform wired or wireless communication. The display apparatus 1150 is, for example, a liquid crystal display screen, an LED display screen, a touch display screen, etc. The input apparatus 1160 may include, for example, a touch screen, a keyboard, etc.

In this embodiment, the memory 1120 of the server 1100 is used to store instructions, which are used to control the processor 1110 to operate, in order to at least perform the method according to any one embodiment of the present description. Technicians may design the instructions according to the solution disclosed in the present description. It is well known in the art how the instructions control the processor to operate, which will not be described in detail herein.

Although multiple apparatuses of the server 1100 are shown in FIG. 1, the present description may only refer to a part of the apparatuses. For example, the server 1100 only refers to the memory 1120 and the processor 1110.

In an embodiment, as shown in FIG. 2, the electronic device 1000 may be a terminal device 1200, such as a PC machine, a laptop, etc., used by an operator, which is not limited herein.

In this embodiment, referring to FIG. 2, the terminal device 1200 may include a processor 1210, a memory 1220, an interface apparatus 1230, a communication apparatus 1240, a display apparatus 1250, an input apparatus 1260, a loudspeaker 1270, a microphone 1280, etc.

The processor 1210 may be a mobile processor. The memory 1220 includes, for example, an ROM (read only memory), an RAM (random access memory), a non-volatile memory (such as a hard disk), etc. The interface apparatus 1230 includes, for example, an USB interface, an earphone interface, etc. The communication apparatus 1240 may, for example, perform wired or wireless communication. The communication apparatus 1240 may include a short-distance communication apparatus, for example, any apparatus that performs short-distance wireless communication based on a short-distance wireless communication protocol, such as Hilink protocol, WiFi (IEEE 802.11 protocol), Mesh, Bluetooth, ZigBee, Thread, Z-Wave, NFC, UWB, LiFi, etc. The communication apparatus 1240 may also include a long-distance communication apparatus, for example, any apparatus that performs WLAN, GPRS, 2G/3G/4G/5G long-distance communication. The display apparatus 1250 is, for example, a liquid crystal display screen, a touch display screen, etc. The input apparatus 1260 may include, for example, a touch screen, a keyboard, etc. A user may input/output voice information through the loudspeaker 1270 and the microphone 1280.

In this embodiment, the memory 1220 of the terminal device 1200 is used to store instructions, which are used to control the processor 1210 to operate, in order to at least perform the method according to any one embodiment of the present description. Technicians may design the instructions according to the solution disclosed in the present description. It is well known in the art how the instructions control the processor to operate, which will not be described in detail herein.

Although multiple apparatuses of the terminal device 1200 are shown in FIG. 2, the present description may only refer to a part of the apparatuses. For example, the terminal device 1200 only refers to the memory 1220, the processor 1210, and the display apparatus 1250.

<Application Scene>

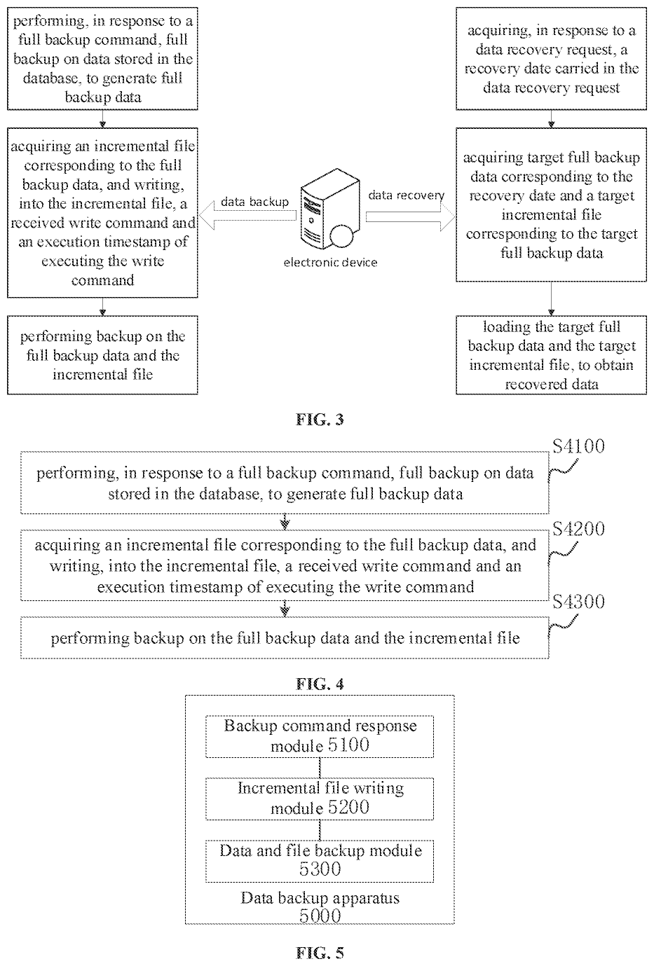

FIG. 3 is a schematic diagram of a scene of an embodiment of the present description.

As shown in FIG. 3, the electronic device of this embodiment may perform data backup. Specifically, the electronic device may perform, in response to a full backup command, full backup on data stored in the database, to generate full backup data: acquire an incremental file corresponding to the full backup data, and write, into the incremental file, a received write command and an execution timestamp of executing the write command; and perform backup on the full backup data and the incremental file.

In this embodiment, in the case of performing the full backup on the database, the write command and the execution timestamp of the write command are also written into the incremental file, and the accurate backup of the database is achieved through both the full backup data and the incremental file, such that on the basis of ensuring overall compatibility, the database may support an instant recovery function after the backup of the database, and the database may accurately recover to data at any time based on the full backup data and the incremental file.

The electronic device of this embodiment may perform data recovery. Specifically, the electronic device may acquire, in response to a data recovery request, a recovery date carried in the data recovery request; acquire target full backup data corresponding to the recovery date and a target incremental file corresponding to the target full backup data; and load the target full backup data and the target incremental file, to obtain recovered data.

In this embodiment, the database may realize the instant recovery function according to the target full backup data, corresponding to the recovery date, that has been backed up in advance and the target incremental file corresponding to the target full backup data, and the database may accurately recover to data at any time.

<Embodiment of Data Backup Method>

In this embodiment, a data backup method based on a database is provided. The data backup method may be implemented by an electronic device. The electronic device may include a server and/or a terminal device. In an example, the server may be the server 1100 as shown in FIG. 1, and the terminal device may be the terminal device 1200 as shown in FIG. 2. Specifically, the electronic device implementing the embodiments of the present description may be provided with a database. The database may be a nosql database, for example, Reids.

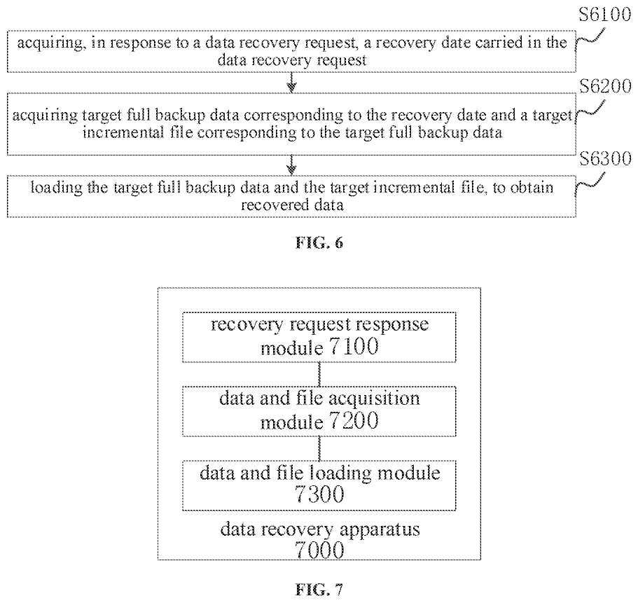

As shown in FIG. 4, the data backup method of this embodiment may include the following Step S4100 to Step S4300.

Step S4100, performing, in response to a full backup command, full backup on data stored in the database, to generate full backup data.

In an embodiment of the present description, the full backup command may be sent by a client to the database according to a preset backup strategy. The backup strategy may have been set in advance according to an application scene or specific needs. For example, the client may send the full backup command to the database regularly every day; and the client may also send, in a case where the client detects that resources occupied by the electronic device are less than or equal to a corresponding set value, the full backup command to the database.

In this embodiment, the resources occupied may at least include any one of the following: CPU utilization, GPU utilization, memory usage, etc.

In a case where the client sends the full backup command to the database regularly every day, the time to send the full backup command may be specified by a user according to needs of the user, or the time to send the full backup command may be set by a system by default. For example, the time to send the full backup command may be set as 2:00 a.m., to avoid the full backup affecting the normal use of the database.

In this embodiment, the full backup data generated by performing the full backup on the data stored in the database may be an rdb file. The rdb file may be obtained by the Redis, through a data persistence manner RDB, saving current dataset snapshots in a memory.

RDB persistence refers to writing dataset snapshots in a memory into a disk within a specified time interval. The RDB persistence is also a default persistence manner, which is to write data in a memory into a binary file in the form of snapshots. The file name of the binary file is dump.rdb by default.

Three mechanisms are provided for RDB: save, bgsave, and automation.

A save command will block the current Redis server. During the execution of the save command, the Redis cannot process other commands until the RDB process is completed. In a case where there is an old rdb file when the execution is completed, the old rdb file is replaced with a new rdb file.

When a bgsave command is executed, the Redis performs a snapshot operation asynchronously in background, and the snapshot may also respond to a client request. The specific operation is that a main process of the Redis performs a fork operation to create subprocesses, and the subprocesses are responsible for the RDB persistence process, which automatically ends after the RDB persistence process is completed. The blocking only occurs in the fork phase, and generally takes a short time. Basically, all RDB operations within the Redis use the bgsave command.

Automatic triggering is completed by the configuration file of the user. There are the following configurations in the Redis.conf configuration file. The following configurations may be set: save, stop-writes-on-bgsave-error, rdbcompression, rdbchecksum, dbfilename, and dir.

The save is used to configure a RDB persistence condition that triggers the Redis, that is, when to save the data in the memory. For example, “save m n” means that, in a case where a dataset is amended n times within m seconds, the bgsave command is automatically triggered. In a case where persistence is not required, all save lines may be commented out to disable the full backup function.

The default value of the stop-writes-on-bgsave-error is yes. In a case where RDB is enabled and the background fails to save data in the last time, the Redis stops receiving the data or does not stop receiving the data. This will make a user realize that the data is not properly persisted to the disk; otherwise, no one will notice the occurrence of the disaster. In a case where the Redis is restarted, the Redis may restart receiving the data.

The default value of the rdbcompression is yes. For snapshots to be stored into a disk, whether the snapshots are compressed and stored into the disk may be set.

The default value of the rdbchecksum is yes. After the snapshots are stored, the Redis may also use a CRC64 algorithm to preform data verification, but this will increase the performance consumption by about 10%. In the case of wanting to get the maximum performance improvement, this function may be turned off.

The dbfilename is used for setting the file name of the snapshots. The file name is dump.rdb by default.

The dir is used for setting the storage path of the snapshot file. This configuration item must be a directory, but cannot be a file name.

The RDB file is once full backup. The RDB file stores the binary serialized form of memory data, which is very compact in storage.

In an embodiment of the present description, the performing, in response to the full backup command, the full backup on the data stored in the database, to generate the full backup data, may include the following Step S4110 to Step S4120.

Step S4110, copying, in response to the full backup command, a main process to generate a subprocess, such that the main process processes a subsequently received command.

Step S4120, performing, through the subprocess, the full backup on the data stored in the database, to generate the full backup data.

In a case where RDB snapshot persistence is performed, the main process of the Redis forks (copies) a subprocess, and the subprocess is responsible for the RDB snapshot persistence. The subprocess owns the current memory data of the main process and performs a snapshot operation on the current memory data.

In the process of the RDB snapshot persistence, the main process does not need to perform any disk IO operation. The main process may process commands received by the Redis subsequently to amend the memory, and the subprocess will not make a response. Therefore, the data amended during the RDB snapshot persistence will not be saved to the rdb file.

Step S4200, acquiring an incremental file corresponding to the full backup data, and writing, into the incremental file, a received write command and an execution timestamp of executing the write command.

In this embodiment, the incremental file may be an aof file. In a case where an AOF function is enabled, the Redis performs AOF snapshot persistence. The Redis appends each received write command to the aof file through a write function. Therefore, the aof file records changes in data in the Redis.

Specifically, the main process of the Redis may fork (copy) a subprocess, the main process may still perform services, and the subprocess may perform the AOF persistence. In the process of background subprocess persistence, the main process may record all data changes during the process (the main process is still in service), and store the data changes into the server.aof_rewrite_buf_blocks. After the background subprocess is ended, the Redis updates data in a cache and appended data in the cache to the aof file.

In the embodiment of the present description, the Redis may not only append each received write command to the aof file, but also write an execution timestamp of each write command to the aof file. Herein, the execution timestamp is specifically a timestamp of executing a corresponding write command.

In an embodiment of the present description, the method may further include: determining a serial number of the write command in a preset incremental manner according to the execution timestamp; and writing the serial number of the write command into the incremental file.

In this embodiment, the preset incremental manner may be sequentially incrementing according to a set step size. The set step size may be set in advance according to an application scene or specific needs. For example, the set step size may be 1. Then, for a first write command and a second write command whose execution timestamps are adjacent, if an execution timestamp of the first write command is earlier than an execution timestamp of the second write command, in a case where the serial number of the first write command is S1, the serial number of the second write command is S2=S1+1.

In an embodiment of the present description, in a case where the main process of the Redis forks a subprocess for RDB snapshot persistence, a new aof file may be opened for incremental write, and the corresponding relationship between the file name of the rdb file and the file name of the new aof file may be written into the rdb.index file.

In an embodiment of the present description, the aof file that is opened and used before the RDB snapshot persistence may also continue to be used, the number of the write commands which have been written in the aof file may be determined as an offset, in the aof file, of a location of a first write command corresponding to the rdb file; and the offset may be recorded in the rdb.index file.

In an embodiment of the present description, the method may further include: generating, in a case where a capacity of the incremental file reaches a preset capacity threshold value, a new incremental file corresponding to the full backup data; writing the received write command and the execution timestamp of executing the write command into the new incremental file; and performing backup on the new incremental file.

This may avoid excessively large incremental files.

In this embodiment, during the AOF snapshot persistence, if the capacity of the aof file exceeds the set capacity threshold value, backup is performed on the aof file, and a new aof file is opened to continue to write write commands. If a bgrewriteaof condition is triggered, a new aof file will also be generated, but the original aof file will not be overwritten.

In this embodiment, the aof file may be uploaded to a preset backup system for backup.

Step S4300, performing backup on the full backup data and the incremental file.

In the embodiment of the present description, the performing backup on the full backup data and the incremental file may refer to uploading the full backup data and the incremental file to the preset backup system for backup. The full backup data and the incremental file may also be saved in a local disk, for use during data recovery.

In an embodiment of the present description, in a case where the full backup data is obtained, the full backup data may be directly uploaded to the backup system for backup, and then the local full backup data that has been backed up may be deleted.

In another embodiment of the present description, in a case where new full backup data is generated, old full backup data may be uploaded to the backup system for backup, such that the electronic device only stores one copy of full backup data.

In an embodiment of the present description, in a case where the capacity of the incremental file exceeds the set capacity threshold value, the incremental file may be uploaded to the backup system for backup.

In another embodiment of the present description, in a case where a new incremental file is generated, an old incremental file may be uploaded to the backup system for backup, such that the electronic device only stores one copy of incremental file.

In this embodiment, in a case where the full backup is performed on the database, the write command and the execution timestamp of the write command may also be written into the incremental file, and the accurate backup of the database is achieved through both the full backup data and the incremental file, such that on the basis of ensuring overall compatibility, the database may support an instant recovery function after the backup of the database, and the database may accurately recover to data at any time based on the full backup data and the incremental file.

In an embodiment of the present description, the method may further include: acquiring, in response to a command for deleting the incremental file, a target serial number carried in the command for deleting the incremental file; wherein, the target serial number is greater than a serial number of a write command last executed in the incremental file that has been backed up: and deleting an incremental file including a write command whose serial number is less than the target serial number.

In an embodiment, the command for deleting the incremental file may be triggered by a user, or may be automatically triggered in a case where the backup system completes the backup of the incremental file. The command for deleting the incremental file carries a target serial number. If the serial number of a write command last executed in an incremental file that has been backed up is Sn, the target serial number Sm is greater than Sn, for example, Sm may be Sn+1. This may ensure the security of the incremental file.

The electronic device implementing this embodiment may store at least one incremental file that has been backed up. In a case where the serial number of the last write command in any one of the at least one incremental file is less than the target serial number, the incremental file is deleted; and in a case where the serial number of the last write command in any one of the at least one incremental file is greater than the target serial number, the incremental file is retained.

<Embodiment of Data Backup Apparatus>

In this embodiment, a data backup apparatus based on a database 5000 is provided. As shown in FIG. 5, the data backup apparatus based on a database 5000 includes a backup command response module 5100, an incremental file writing module 5200, and a data and file backup module 5300. The backup command response module 5100 is configured for performing, in response to a full backup command, full backup on data stored in the database, to generate full backup data. The incremental file writing module 5200 is configured for acquiring an incremental file corresponding to the full backup data, and writing, into the incremental file, a received write command and an execution timestamp of executing the write command. The data and file backup module 5300 is configured for performing backup on the full backup data and the incremental file.

In an embodiment of the present description, the backup command response module 5100 may be further configured for: copying, in response to the full backup command, a main process to generate a subprocess, such that the main process processes a subsequently received command; and performing, through the subprocess, the full backup on the data stored in the database, to generate the full backup data.

In an embodiment of the present description, the data backup apparatus based on a database further includes: a module configured for, generating, in a case where a capacity of the incremental file reaches a preset capacity threshold value, a new incremental file corresponding to the full backup data; a module configured for writing the received write command and the execution timestamp of executing the write command into the new incremental file; and a module configured for performing backup on the new incremental file.

In an embodiment of the present description, the data backup apparatus based on a database further includes: a module configured for determining a serial number of the write command in a preset incremental manner according to the execution timestamp; and a module configured for writing the serial number of the write command into the incremental file.

In an embodiment of the present description, the data backup apparatus based on a database further includes: a module configured for, acquiring, in response to a command for deleting the incremental file, a target serial number carried in the command for deleting the incremental file; wherein, the target serial number is greater than a serial number of a write command last executed in the incremental file that has been backed up; and a module configured for deleting an incremental file including a write command whose serial number is less than the target serial number.

Technicians in the art should understand that the data backup apparatus 5000 may be implemented in various ways. For example, the data backup apparatus 5000 may be implemented by an instruction configuration processor. For example, instructions may be stored in an ROM, and when the device is enabled, the instructions are read from the ROM to a programmable device, to implement the data backup apparatus 5000. For example, the data backup apparatus 5000 may be solidified into a special device (such as an ASIC). The data backup apparatus 5000 may be divided into mutually independent units, or these units may be combined to implement the data backup apparatus. The data backup apparatus 5000 may be implemented by one of the above various implementations, or the data backup apparatus 5000 may be implemented by a combination of two or more of the above various implementations.

In this embodiment, the data backup apparatus 5000 may be implemented in multiple forms. For example, the data backup apparatus 5000 may be any functional module running in software products or application programs that provide a data backup service. Alternatively, the data backup apparatus 5000 may be a peripheral embedded part, a plug-in, a patch, etc., of these software products or application programs. Alternatively, the data backup apparatus 5000 may also be these software products or application programs themselves.

<Embodiment of Data Recovery Method>

In this embodiment, a data recovery method based on a database is provided. The data recovery method may be implemented by an electronic device. The electronic device may include a server and/or a terminal device. In an example, the server may be the server 1100 as shown in FIG. 1, and the terminal device may be the terminal device 1200 as shown in FIG. 2. Specifically, the electronic device implementing the embodiments of the present description may be provided with a database. The database may be a nosql database, for example, Reids.

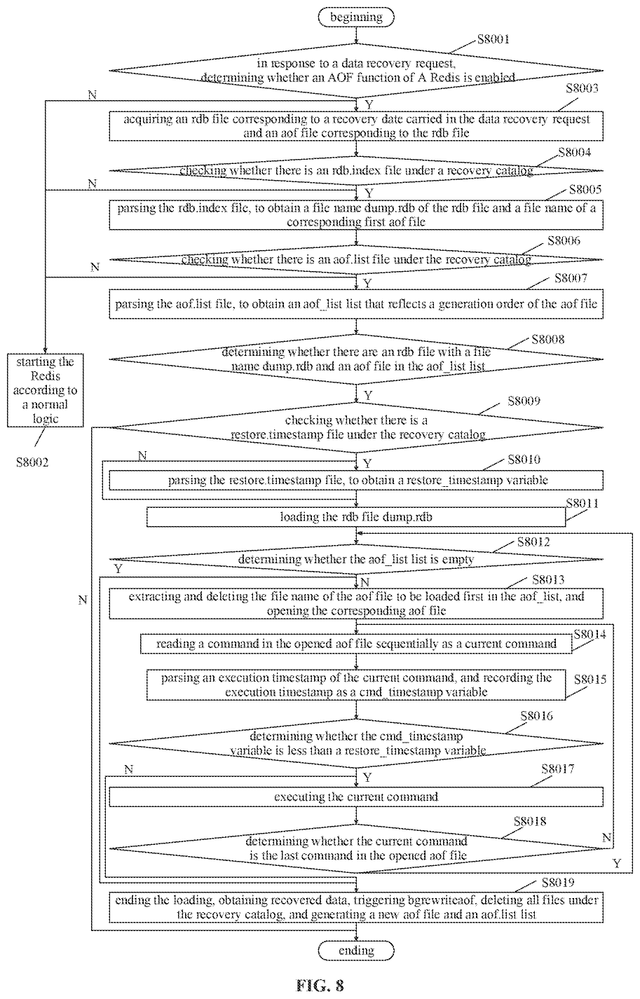

As shown in FIG. 6, the data recovery method of this embodiment may include the following Step S6100 to Step S6200.

Step S6100, acquiring, in response to a data recovery request, a recovery date carried in the data recovery request.

In this embodiment, the data recovery request may be triggered by a user according to needs of the user. In a case where the user triggers the data recovery request, the user may usually specify a recovery date to recover the data in the database to the data at the corresponding date.

Step S6200, acquiring target full backup data corresponding to the recovery date and a target incremental file corresponding to the target full backup data.

In this embodiment, the target full backup data and the target incremental file are obtained according to the data backup method in the preceding embodiment.

In the backup system, multiple copies of full backup data and at least one incremental file corresponding to each copy of full backup data may be stored.

The full backup data may be obtained by performing full backup on the data in the database regularly every day. Therefore, multiple copies of full backup data stored in the backup system have corresponding date information. For example, each copy of full backup data may be named by the date.

Then, the full backup data with the same generation date and the same recovery date may be acquired as the target full backup data.

In an embodiment of the present description, in the electronic device implementing this embodiment or the backup system, the corresponding relationship between the full backup data and the incremental file, as well as the incremental file corresponding to the target full backup data may be stored. Specifically, the corresponding relationship between the full backup data and the incremental file may be stored through the rdb.index file. In this embodiment, the target incremental file is the incremental file corresponding to the target full backup data.

In this embodiment, the target full backup data and the target incremental file may be downloaded from the backup system, or may be stored in advance in the electronic device implementing this embodiment.

Step S6300, loading the target full backup data and the target incremental file, to obtain recovered data.

In an embodiment of the present description, the loading the target full backup data and the target incremental file to obtain the recovered data, may include the following Step S6310 to Step S6340.

Step S6310, acquiring a full backup index file and an incremental list file, which are generated by a peripheral system according to the target full backup data and the target incremental file.

Herein, the full backup index file is used to represent both the target incremental file corresponding to the target full backup data, and a serial number of a write command, corresponding to the target full backup data, in the target incremental file, and the incremental list file is used to represent a generation order of the target incremental file.

In the embodiment of the present description, the full backup index file may be an rdb.index file. The content of the rdb.index file is one line of text in the format: rdb_file_name aof_file_name offset first_cmd_seq. Herein, rdb_file_name represents a file name of target full backup data, aof_file_name represents a file name of a first target incremental file corresponding to the target full backup data in a case where the target full backup data is generated, offset represents an offset, in the aof file, of a location where a first write command, corresponding to the target full backup data, in the first target incremental file is located, and first_cmd_seq represents a serial number corresponding to the first write command in the first target incremental file. For example, the content of the rdb.index file may be: dump.rdb aof_1 0 10.

Through the rdb.index index technology, the AOF incremental backup mechanism and the rdb full backup mechanism of Redis may be used at the same time. When recovery, the rdb file is first used for data recovery, and then the first AOF file corresponding to the rdb file is found through the rdb.index, to continue incremental recovery.

The incremental list file may be an aof.list file. The aof.list file is a global view of all current target incremental files. The content of the aof list file has a format containing multiple lines of texts. The format of each text is: aof_file_name start_seq end_seq aof_type timestamp. Herein, aof_file_name is a file name of a target incremental file; start_seq/end_seq represent respectively serial numbers of the first write command and the last write command in write commands contained in the target incremental file; aof_type represents a type of the target incremental file, and the type may be new or history, and timestamp is a time when the target incremental file is created.

By introducing the aof.list file as a metadata file of the AOF file, an overall view of the current AOF file may be provided to the Redis and the peripheral backup system.

In this embodiment, the peripheral system is a processing system, other than the Redis, in the electronic device. The peripheral system may generate a full backup index file and an incremental list file according to the target full backup data and the target incremental file.

Step S6320, parsing the full backup index file and the incremental list file to obtain a parsing result.

By parsing the full backup index file, the first target incremental file corresponding to the target full backup data, and the serial number of the first write command, corresponding to the target full backup data, in the first target incremental file may be determined.

By parsing the incremental list file, the generation order of multiple target incremental files may be obtained. Specifically, file names of the first target incremental file and all target incremental files generated after the first target incremental file may be placed in one list in the sequential order of generation time. For example, the list may be an aof_list list.

Step S6330, loading the target full backup data.

Step S6340, loading, after the target full backup data is loaded successfully, the target incremental file according to the parsing result, to obtain the recovered data.

In an embodiment of the present description, if a user does not set a specific time within the recovery date when the user triggers a data recovery request, the target incremental files are loaded successively according to the order recorded in the aof_list list, after the target full backup data is loaded successfully.

In the process of loading any one target incremental file, write commands in the target incremental file may be executed in chronological order according to timestamps of the write commands in the target incremental file.

For the first target incremental file and the last target incremental file, write commands that do not correspond to the target full backup data may also be recorded. Therefore, when the first target incremental file is loaded, the write command to be executed first may be determined according to the serial number of the first write command, corresponding to the target full backup data, in the first target incremental file, and executed. When the last target incremental file is loaded, the serial number of the last write command corresponding to the target full backup data may be determined, and after the last write command is executed, the data recovery is completed and the recovered data is obtained.

In an embodiment of the present description, the method may also include: acquiring a timestamp file, which is generated by the peripheral system according to a recovery timestamp within the recovery date; and parsing the timestamp file to obtain the recovery timestamp, and loading the target incremental file according to the recovery timestamp, to obtain the recovered data.

In an embodiment of the present description, the timestamp file may be a restore.timestamp file. The content of the restore.timestamp file may be parsed to obtain a unix timestamp, i.e., a recovery timestamp, and the recovery timestamp is set as a restore_timestamp variable.

The loading the target full backup data and the target incremental file according to the parsing result and the recovery timestamp to obtain the recovered data, includes: acquiring a target write command in the target incremental file sequentially according to the parsing result, and in a case where an execution timestamp corresponding to the target write command precedes the recovery timestamp, executing the target write command to obtain the recovered data.

In this embodiment, the target write command may specifically be a write command, corresponding to the target full backup data, in the target incremental file.

Specifically, target write commands whose execution timestamps precede the recovery timestamp may be filtered out, such that the database accurately recovers to the data state before the recovery timestamp of the recovery date.

In a case where the Redis executes the target command, the Redis may track the maximum serial number of the target write command that has been currently executed, and the Redis directly skips and does not execute a target write command whose serial number is less than the maximum serial number, thereby ensuring the uniqueness of execution of the write command in the target incremental file.

In this embodiment, the database may realize the instant recovery function according to the target full backup data, corresponding to the recovery date, that has been backed up in advance and the target incremental file corresponding to the target full backup data, and the database may accurately recover to data at any time.

In an embodiment of the present description, after the target incremental file is loaded, files, such as the rdb.index, the aof list, the restore.timestamp, the rdb, and the aof, under the recovery catalog are unnecessary. Therefore, the Redis may automatically trigger bgrewriteaof once, deletes all these files, generates a new aof file, and updates the information of the aof.list file. So far, the Redis may start to service the request of the client in an initial state.

<Embodiment of Data Recovery Apparatus>

In this embodiment, a database-based data recovery apparatus 7000 is provided. As shown in FIG. 7, the data recovery apparatus 7000 includes: a recovery request response module 7100, a data and file acquisition module 7200, and a data and file loading module 7300. The recovery request response module 7100 is configured for acquiring, in response to a data recovery request, a recovery date carried in the data recovery request. The data and file acquisition module 7200 is configured for acquiring target full backup data corresponding to the recovery date and a target incremental file corresponding to the target full backup data; herein, the target full backup data and the target incremental file are obtained through the apparatus according to the third aspect of the present description. The data and file loading module 7300 is configured for loading the target full backup data and the target incremental file, to obtain recovered data.

In an embodiment of the present description, the data and file loading module 7300 may be further configured for: acquiring a full backup index file and an incremental list file, which are generated by a peripheral system according to the target full backup data and the target incremental file, wherein the full backup index file is used to represent both the target incremental file corresponding to the target full backup data, and a serial number of a write command, corresponding to the target full backup data, in the target incremental file, and the incremental list file is used to represent a generation order of the target incremental file; parsing the full backup index file and the incremental list file to obtain a parsing result; loading the target full backup data; and loading, after the target full backup data is loaded successfully, the target incremental file according to the parsing result, to obtain the recovered data.

In an embodiment of the present description, the data recovery apparatus 7000 may further include: a module configured for acquiring a timestamp file, which is generated by the peripheral system according to a recovery timestamp within the recovery date; and a module configured for parsing the timestamp file to obtain the recovery timestamp, and loading the target incremental file according to the recovery timestamp, to obtain the recovered data.

In an embodiment of the present description, the loading the target full backup data and the target incremental file according to the parsing result and the recovery timestamp to obtain the recovered data, includes: acquiring a target write command in the target incremental file sequentially according to the parsing result, and in a case where an execution timestamp corresponding to the target write command precedes the recovery timestamp, executing the target write command to obtain the recovered data.

Technicians in the art should understand that the data recovery apparatus 7000 may be implemented in various ways. For example, the data recovery apparatus 7000 may be implemented by an instruction configuration processor. For example, instructions may be stored in an ROM, and when the device is enabled, the instructions are read from the ROM to a programmable device, to implement the data recovery apparatus 7000. For example, the data recovery apparatus 7000 may be solidified into a special device (such as an ASIC). The data recovery apparatus 7000 may be divided into mutually independent units, or these units may be combined to implement the data backup apparatus. The data recovery apparatus 7000 may be implemented by one of the above various implementations, or the data recovery apparatus 7000 may be implemented by a combination of two or more of the above various implementations.

In this embodiment, the data recovery apparatus 7000 may be implemented in multiple forms. For example, the data recovery apparatus 7000 may be any functional module running in software products or application programs that provide a data backup service. Alternatively, the data recovery apparatus 7000 may be a peripheral embedded part, a plug-in, a patch, etc., of these software products or application programs. Alternatively, the data recovery apparatus 7000 may also be these software products or application programs themselves.

### Example

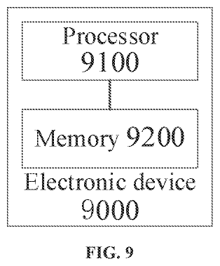

FIG. 8 may be a schematic flow chart of an example of a data recovery method of an embodiment of the present description.

As shown in FIG. 8, the method may include the following Step S8001 to Step S8019.

Step S8001, in response to a data recovery request, determining whether an AOF function of a Redis is enabled; in a case where the AOF function of the Redis is not enabled, performing Step S8002; in a case where the AOF function of the Redis is enabled, performing Step S8003.

Step S8002, starting the Redis according to a normal logic.

Step S8003, acquiring an rdb file corresponding to a recovery date carried in the data recovery request and an aof file corresponding to the rdb file.

Step S8004, checking whether there is an rdb.index file under a recovery catalog; in a case where there is the rdb.index file under the recovery catalog, performing the Step S8005; and there is not the rdb.index file under the recovery catalog, performing the Step S8002.

Step S8005, parsing the rdb.index file to obtain a file name dump.rdb of the rdb file and a file name aof_1 of the first aof file corresponding to the rdb file.

Step S8006, checking whether there is an aof.list file under the recovery catalog; in a case where there is the aof.list file under the recovery catalog, performing the Step S8007; and there is not the aof.list file under the recovery catalog, performing the Step S8002.

Step S8007, parsing the aof.list file, to obtain an aof_list list that reflects a generation order of the aof file.

Step S8008, determining whether there are an rdb file with a file name dump.rdb and an aof file in the aof_list list; in a case where there are the rdb file with the file name dump.rdb and the aof file in the aof_list list, performing the Step S8009; and in a case where there are not the rdb file with the file name dump.rdb and the aof file in the aof_list list, ending.

Step S8009, checking whether there is a restore.timestamp file under the recovery catalog; in a case where there is the restore.timestamp file under the recovery catalog, performing the Step S8010; and in a case where there is not the restore.timestamp file under the recovery catalog, performing the Step S8011.

Step S8010, parsing the restore.timestamp file, to obtain a restore_timestamp variable.

Step S8011, loading the rdb file dump.rdb.

Step S8012, determining whether the aof_list list is empty; in a case where the aof_list list is not empty, performing the Step S8013; and in a case where the aof_list list is empty, performing the Step S8019.

Step S8013, extracting and deleting the file name of the aof file to be loaded first in the aof_list, and opening the corresponding aof file.

Step S8014, reading a command in the opened aof file sequentially as a current command.

Step S8015, parsing an execution timestamp of the current command, and recording the execution timestamp as a cmd_timestamp variable.

Step S8016, determining whether the cmd_timestamp variable is less than a restore_timestamp variable; in a case where the cmd_timestamp variable is less than the restore_timestamp variable, performing the Step S8017; and in a case where the cmd_timestamp variable is not less than the restore_timestamp variable, performing the Step S8019.

Step S8017, executing the current command.

Step S8018, determining whether the current command is the last command in the opened aof file; in a case where the current command is the last command in the opened aof file, performing the Step S8014; in a case where the current command is not the last command in the opened aof file, performing the Step S8019.

Step S8019, ending the loading, obtaining recovered data, triggering bgrewriteaof, deleting all files under the recovery catalog, and generating a new aof file and an aof.list list.

<Electronic Device>

In this embodiment, an electronic device 9000 is also provided. The electronic device 9000 may include the server 1100 shown in FIG. 1, and may also include the terminal device 1200 shown in FIG. 2.

On the one hand, the electronic device 9000 may include the above data backup apparatus 5000 that is configured for implementing the data backup method according to any one embodiment of the present description; or, the electronic device 9000 may include the above data recovery apparatus 7000 that is configured for implementing the data recovery method according to any one embodiment of the present description.

On the other hand, as shown in FIG. 9, the electronic device 9000 may also include a processor 9100 and a memory 9200. The memory 9200 is configured for storing executable instructions. The processor 9100 is configured for running the electronic device 9000 according to the control of the instructions, to perform the method according to any one embodiment of the present description.

<Computer-Readable Storage Medium>

In this embodiment, a computer-readable storage medium is also provided. The computer-readable storage medium stores a computer program. The computer program, when executed by a processor, implements the method according to any one embodiment of the present description.

The present description may be a system, a method, and/or a computer program product. The computer program product may include a computer-readable storage medium. The computer-readable storage medium is loaded with computer-readable program instructions for enabling a processor to implement various aspects of the present description.

The computer-readable storage medium may be a tangible device that may hold and store instructions used by an instruction execution device. The computer-readable storage medium may be, for example, but is not limited to, an electric storage device, a magnetic storage device, an optical storage device, an electromagnetic storage device, a semiconductor storage device, or any suitable combination of the above devices. More specific examples of the computer-readable storage medium (non exhaustive list) include: a portable computer disk, a hard disk, a random access memory (RAM), a read-only memory (ROM), an erasable programmable read-only memory (EPROM or flash memory), a static random access memory (SRAM), a portable compressed disk read-only memory (CD-ROM), a digital versatile disk (DVD), a memory stick, a floppy disk, a mechanical coding device (such as a convex structure in a groove or a punched card that stores instructions), and any suitable combination of the above. The computer-readable storage medium used herein is not interpreted as an instantaneous signal itself, such as radio waves or other freely propagating electromagnetic waves, electromagnetic waves propagating through waveguides or other transmission media (for example, optical pulses passing through optical fiber cables), or electrical signals transmitted through wires.

The computer-readable program instructions described herein may be downloaded from a computer-readable storage medium to various computing/processing devices, or may be downloaded to an external computer or an external storage device through a network, such as the Internet, a local area network, a wide area network, and/or a wireless network. The network may include copper transmission cables, optical fiber transmission, wireless transmission, routers, firewalls, switches, gateway computers, and/or edge servers. A network adapter card or network interface in each of the computing/processing devices receives the computer-readable program instructions from the network, and forwards the computer-readable program instructions for storage in the computer-readable storage medium in each of the computing/processing devices.

The computer program instructions for performing the operations of the present description may be assembly instructions, instruction set architecture (ISA) instructions, machine instructions, machine related instructions, microcodes, firmware instructions, state setting data, or source codes or object codes written in any combination of one or more programming languages. The programming languages include object-oriented programming languages, such as Smalltalk, C++, etc., and conventional procedural programming languages, such as a “C” language or a similar programming language. The computer-readable program instructions may be executed completely on a computer of a user, executed partially on the computer of the user, executed as a separate software package, executed partially on the computer of the user and partially on a remote computer, or executed completely on the remote computer or a server. In the case of the remote computer, the remote computer may be connected to the computer of the user through any kind of network, including a local area network (LAN) or a wide area network (WAN), or may be connected to an external computer (for example, through the Internet using an Internet service provider). In some embodiments, electronic circuits, such as programmable logic circuits, field programmable gate arrays (FPGAs), or programmable logic arrays (PLAs), are personalized and customized by using the state information of computer-readable program instructions. The electronic circuits may execute the computer-readable program instructions, thereby realizing various aspects of the present description.

Various aspects of the present description are described herein with reference to flow charts and/or block diagrams of the method, the apparatus (system), and the computer program product according to the embodiments of the present description. It should be understood that each block of the flow charts and/or block diagrams and the combination of various blocks of the flow charts and/or block diagrams may be implemented by computer-readable program instructions.

These computer-readable program instructions may be provided to a processor of a general-purpose computer, a special purpose computer or other programmable data processing apparatuses, to produce a machine, such that when these instructions are executed by the processor of the computer or other programmable data processing apparatuses, an apparatus that implements the functions/actions specified in one or more blocks of the flow charts and/or block diagrams is produced. These computer-readable program instructions may also be stored in a computer-readable storage medium. These instructions enable a computer, a programmable data processing apparatus, and/or other devices to operate in a specific manner, such that a computer-readable medium storing the instructions includes a manufacture that includes instructions for implementing various aspects of the functions/actions specified in one or more blocks of the flow charts and/or block diagrams.

The computer-readable program instructions are also loaded to a computer, other programmable data processing apparatuses, or other devices, such that a series of operation steps are performed on the computer, other programmable data processing apparatuses, or other devices to generate a process implemented by a computer, and then the instructions executed on the computer, other programmable data processing apparatuses, or other devices implement the functions/actions specified in one or more blocks of the flow charts and/or block diagrams.

The flow charts and block diagrams in the drawings show the possible implemented architectures, functions, and operations of the system, method, and computer program product according to multiple embodiments of the present description. In this regard, each block in a flow charts or block diagrams may represent a module, a program segment, or a part of instructions. The module, the program segment, or the part of the instructions contains one or more executable instructions for implementing a specified logical function. In some alternative implementations, functions marked in the blocks may also occur in an order different from the order marked in the drawings. For example, two successive blocks may actually be executed basically in parallel, and the two successive blocks may also sometimes be executed in the opposite order, depending on the function involved. It should also be noted that each block in the block diagrams and/or flow charts and the combination of blocks in the block diagrams and/or flow charts may be implemented by a dedicated hardware-based system performing specified functions or actions, or implemented by a combination of dedicated hardware and computer instructions. It is well known to technicians in the art that implementations by hardware, by software, and by a combination of software and hardware are equivalent. Various embodiments of the present description have been described above. The above description is exemplary, not exhaustive, and is not limited to the disclosed various embodiments. Without deviating from the scope and spirit of the described embodiments, many modifications and changes are obvious to ordinary technicians in the art. The terms used herein are selected to best explain the principle, practical application, or technical improvement in the market of various embodiments, or to enable other ordinary technicians in the art to understand various embodiments disclosed herein. The scope of the present description is defined by the appended claims.

1. A data backup method based on a database, comprising:
performing, in response to a full backup command, full backup on data stored in the database, to generate full backup data;
acquiring an incremental file corresponding to the full backup data, and writing, into the incremental file, a received write command and an execution timestamp of executing the write command; and
performing backup on the full backup data and the incremental file.

2. The method of claim 1, wherein the performing, in response to the full backup command, the full backup on the data stored in the database, to generate the full backup data, comprises:
copying, in response to the full backup command, a main process to generate a subprocess, such that the main process processes a subsequently received command; and
performing, through the subprocess, the full backup on the data stored in the database, to generate the full backup data.

3. The method of claim 1, further comprising:
generating, in a case where a capacity of the incremental file reaches a preset capacity threshold value, a new incremental file corresponding to the full backup data;
writing the received write command and the execution timestamp of executing the write command into the new incremental file; and
performing backup on the new incremental file.

4. The method of claim 1, further comprising:
determining a serial number of the write command in a preset incremental manner according to the execution timestamp; and
writing the serial number of the write command into the incremental file.

5. The method of claim 4, further comprising:
acquiring, in response to a command for deleting the incremental file, a target serial number carried in the command for deleting the incremental file; wherein, the target serial number is greater than a serial number of a write command last executed in the incremental file that has been backed up; and
deleting an incremental file comprising a write command whose serial number is less than the target serial number.

6. A data recovery method based on a database, comprising:
acquiring, in response to a data recovery request, a recovery date carried in the data recovery request;
acquiring target full backup data corresponding to the recovery date and a target incremental file corresponding to the target full backup data; wherein, the target full backup data and the target incremental file are obtained through the method of claim 1; and
loading the target full backup data and the target incremental file, to obtain recovered data.

7. The method of claim 6, wherein the loading the target full backup data and the target incremental file to obtain the recovered data, comprises:
acquiring a full backup index file and an incremental list file, which are generated by a peripheral system according to the target full backup data and the target incremental file, wherein the full backup index file is used to represent both the target incremental file corresponding to the target full backup data, and a serial number of a write command, corresponding to the target full backup data, in the target incremental file, and the incremental list file is used to represent a generation order of the target incremental file;
parsing the full backup index file and the incremental list file to obtain a parsing result;
loading the target full backup data; and
loading, after the target full backup data is loaded successfully, the target incremental file according to the parsing result, to obtain the recovered data.

8. The method of claim 7, further comprising:
acquiring a timestamp file, which is generated by the peripheral system according to a recovery timestamp within the recovery date; and
parsing the timestamp file to obtain the recovery timestamp, and loading the target incremental file according to the recovery timestamp, to obtain the recovered data.

9. The method of claim 8, wherein the loading the target incremental file according to the parsing result and the recovery timestamp, to obtain the recovered data, comprises:
acquiring a target write command in the target incremental file sequentially according to the parsing result, and in a case where an execution timestamp corresponding to the target write command precedes the recovery timestamp, executing the target write command to obtain the recovered data.

10. A data backup apparatus based on a database, comprising:
at least one processor; and
a memory communicatively connected with the at least one processor,
wherein the memory stores instructions executable by the at least one processor, and the instructions, when executed by the at least one processor, cause the at least one processor to perform operations of:
performing, in response to a full backup command, full backup on data stored in the database, to generate full backup data;
acquiring an incremental file corresponding to the full backup data, and writing, into the incremental file, a received write command and an execution timestamp of executing the write command; and
performing backup on the full backup data and the incremental file.

11. data recovery apparatus based on a database, comprising:
at least one processor; and
a memory communicatively connected with the at least one processor,
wherein the memory stores instructions executable by the at least one processor, and the instructions, when executed by the at least one processor, cause the at least one processor to perform operations of:
acquiring, in response to a data recovery request, a recovery date carried in the data recovery request;
acquiring target full backup data corresponding to the recovery date and a target incremental file corresponding to the target full backup data; wherein, the target full backup data and the target incremental file are obtained through the apparatus of claim 10; and
loading the target full backup data and the target incremental file, to obtain recovered data.

12. (canceled)

13. A computer-readable storage medium, storing a computer program, wherein, the computer program, when executed by a processor, implements the method of claim 1.

14. The apparatus of claim 10, wherein the instructions, when executed by the at least one processor, cause the at least one processor to further perform operations of:
copying, in response to the full backup command, a main process to generate a subprocess, such that the main process processes a subsequently received command; and
performing, through the subprocess, the full backup on the data stored in the database, to generate the full backup data.

15. The apparatus of claim 10, wherein the instructions, when executed by the at least one processor, cause the at least one processor to further perform operations of:
generating, in a case where a capacity of the incremental file reaches a preset capacity threshold value, a new incremental file corresponding to the full backup data;
writing the received write command and the execution timestamp of executing the write command into the new incremental file; and
performing backup on the new incremental file.

16. The apparatus of claim 10, wherein the instructions, when executed by the at least one processor, cause the at least one processor to further perform operations of:
determining a serial number of the write command in a preset incremental manner according to the execution timestamp; and
writing the serial number of the write command into the incremental file.

17. The apparatus of claim 16, wherein the instructions, when executed by the at least one processor, cause the at least one processor to further perform operations of:
acquiring, in response to a command for deleting the incremental file, a target serial number carried in the command for deleting the incremental file; wherein, the target serial number is greater than a serial number of a write command last executed in the incremental file that has been backed up; and
deleting an incremental file comprising a write command whose serial number is less than the target serial number.

18. The apparatus of claim 11, wherein the instructions, when executed by the at least one processor, cause the at least one processor to further perform operations of:
acquiring a full backup index file and an incremental list file, which are generated by a peripheral system according to the target full backup data and the target incremental file, wherein the full backup index file is used to represent both the target incremental file corresponding to the target full backup data, and a serial number of a write command, corresponding to the target full backup data, in the target incremental file, and the incremental list file is used to represent a generation order of the target incremental file;
parsing the full backup index file and the incremental list file to obtain a parsing result;
loading the target full backup data; and
loading, after the target full backup data is loaded successfully, the target incremental file according to the parsing result, to obtain the recovered data.

19. The apparatus of claim 18, wherein the instructions, when executed by the at least one processor, cause the at least one processor to further perform operations of:
acquiring a timestamp file, which is generated by the peripheral system according to a recovery timestamp within the recovery date; and
parsing the timestamp file to obtain the recovery timestamp, and loading the target incremental file according to the recovery timestamp, to obtain the recovered data.

20. The apparatus of claim 19, wherein the instructions, when executed by the at least one processor, cause the at least one processor to further perform an operation of:
acquiring a target write command in the target incremental file sequentially according to the parsing result, and in a case where an execution timestamp corresponding to the target write command precedes the recovery timestamp, executing the target write command to obtain the recovered data.

21. A computer-readable storage medium, storing a computer program, wherein, the computer program, when executed by a processor, implements the method of claim 6.
